(19) United States
(12) Patent Application Publication
(10) Pub. No.: US 2014/0233569 A1
(43) Pub. Date: Aug. 21, 2014

(54) Distributed Gateway in Virtual Overlay Networks

(71) Applicant: Futurewei Technologies, Inc., Plano, T (US)

(72) Inventors: Lucy Yong, Georgetown, TX (US); Linda Dunbar, Plano, TX (US)

(73) Assignee: Futurewei Technologies, Inc., Plano, TX (US)

(21) Appl. No.: 14/180,636

(22) Filed: Feb. 14, 2014

Related U.S. Application Data
(60) Provisional application No. 61/765,539, filed on Feb. 15, 2013.

(51) Int. Cl. H04L 12/715

(52) U.S. Cl. CPC H04L 45/64
USPC 370/392

(57) ABSTRACT

A method for distributing the inter-network forwarding policies to a distributed gateway located within a network virtualization edge (NVE). The NVE may receive a data packet within a first virtual overlay network and determine that the data packet is destined for a destination end point located within a second virtual overlay network. The NVE may validate the data packet corresponds to an inter-network forwarding policy stored within the distributed gateway and forward the data packet to the second virtual overlay network. Alternatively, the NVE may forward the data packet toward a gateway or query the corresponding policy from a controller if no corresponding inter-network forwarding policy is located on the distributed gateway. A distributed gateway may receive the forwarding policies from a designated gateway or from a centralized controller.

### CROSS-REFERENCE TO RELATED APPLICATIONS

The present application claims priority to U.S. Provisional Patent Application 61/765,539, filed Feb. 15, 2013 by Lucy Yong, and entitled “System and Method for Pseudo Gateway in Virtual Overlay Network,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Computer virtualization has dramatically altered the information technology (IT) industry in terms of efficiency, cost, and the speed in providing new applications and/or services. The trend continues to evolve towards network virtualization, where a set of tenant end points, such as virtual machines (VMs) and/or hosts, may communicate in a virtualized network environment that is decoupled from an underlying physical network, such as a data center (DC) physical network. Constructing virtual overlay networks using network virtualization overlay (NVO3) is one approach to provide network virtualization services to a set of tenant end points within a DC network. NVO3 is described in more detail in the Internet Engineering Task Force (IETF) document, draft-ietf-nvo3-arch-01, published Oct. 22, 2013 and the IETF document, draft-ietf-nvo3-framework-05, published Jan. 4, 2014, both of which are incorporated herein by reference as if reproduced in their entirety. With NVO3, a tenant network may be built over a common DC network infrastructure where the tenant network comprises one or more virtual overlay networks. Each of the virtual overlay networks may have an independent address space, independent network configurations, and traffic isolation amongst each other.

Typically, one or more gateways may be setup for the virtual overlay networks to route data packets between different networks. For example, a gateway may route traffic between two virtual overlay networks within the same tenant network and/or between a virtual overlay network and another type of network, such as another type of virtual network (e.g. virtual local area network (VLAN)), a physical network, and/or the Internet. When routing traffic between two virtual overlay networks, gateways generally receive traffic from one virtual overlay network, update header information for the traffic, and forward the traffic to the other virtual overlay network. Moreover, prior to forwarding traffic between the two virtual overlay networks, the gateways may perform inter-subnet policy-based forwarding and policy checking to determine whether the traffic may be forwarded between virtual overlay networks. Unfortunately, forwarding intra-DC traffic (e.g. data traffic forwarded within a DC network) to the gateways may cause sub-optimal routing. For example, two VMs may belong to two different virtual overlay networks, but may reside on the same server. The communication between the two VMs may traverse the gateway even though the VMs are located on the same server. Thus, the VM unpredictability may create sub-optimal issues or inefficient intra-DC traffic routing by routing the intra-DC traffic to the gateways. In addition, constant inter-subnet policy-based forwarding and policy checking may cause processing bottlenecks at the gateways.

### SUMMARY

In one example embodiment, the disclosure includes a network virtualization edge (NVE) that obtains inter-network forwarding policies for one or more virtual overlay networks. The NVE may receive a data packet within a first virtual overlay network and determine that the data packet is destined for a destination end point located within a second virtual overlay network. The NVE may verify whether a stored inter-network forwarding policy within the NVE corresponds to the packet. The NVE forwards the data packet toward the destination point located within the second virtual overlay network when the data packet corresponds to the inter-network forwarding policy. Alternatively, the NVE forwards the data packet toward a gateway when the data packet does not correspond to the inter-network forwarding policy. The inter-network forwarding policy may be a set of rules used to forward traffic between the first virtual overlay network and the second virtual overlay network.

In another example embodiment, the disclosure includes distributing inter-network forwarding policies to the distributed gateways that may reside the NVEs. The distributed gateways may store a plurality of inter-network forwarding policies for a tenant network. When the distributed gateways receive a data packet within a source virtual overlay network located in the tenant network, the distributed gateways may determine a destination virtual overlay network located in the tenant network for the data packet. The distributed gateway may verify whether one of the inter-network forwarding policies is associated with the destination virtual overlay network. The distributed gateway may forward the data packet toward a destination end point located within the destination virtual overlay network when the destination virtual overlay network is associated with the one of the inter-network forwarding policies or forward the data packet toward a designated gateway when the destination virtual overlay network is not associated with the one of the inter-network forwarding policies. The inter-network forwarding policies may be a plurality of rules used to exchange traffic between a plurality of virtual overlay networks located within the tenant network.

In yet another example embodiment, the disclosure includes a distributed gateway that forwards data traffic depending on whether the distributed gateway has the inter-network forwarding policies. The distributed gateway may receive, within a first virtual network, a data packet comprising an Internet Protocol (IP) destination address and a destination address. The IP destination address may reference an IP address of a destination end point and the destination address references an address of the distributed gateway. The distributed gateway may map the IP destination address to a destination address of the destination end point and a destination virtual network. The distributed gateway may also determine whether an inter-network forwarding policy is stored within the distributed gateway that is used to forward data packets to the destination virtual network. The distributed gateway may transmit the data packet toward the destination end point when the distributed gateway stores the inter-network forwarding policy used to forward the data packet to the destination virtual network or transmit the data packet toward a designated gateway when the distributed gateway does not store the inter-network forwarding policy used to forward the data packet to the destination virtual network.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example embodiment of a DC system where embodiments of the present disclosure may operate.

FIG. 2 is a schematic diagram of another example embodiment of a DC system where embodiments of the present disclosure may operate.

FIG. 3 is a schematic diagram of an embodiment of a network element that may be used to implement a distributed gateway.

FIG. 4 is a schematic diagram of another example embodiment of a DC system where embodiments of the present disclosure may operate.

FIG. 5 illustrates a flowchart of an example embodiment of a method for routing data packets between two virtual overlay networks.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various example embodiments that distribute inter-network forwarding policies (e.g. inter-subnet forwarding policies) to distributed gateways on NVEs such that the distributed gateways are configured to forward data between two or more virtual overlay networks (e.g. subnets). In one example embodiment, a distributed gateway is located on every NVE that participates within the virtual overlay networks. One or more distributed gateways may be distributed in a tenant network and may receive at least some of the inter-network forwarding policies from a gateway and/or centralized controller. A tenant end point participating in a virtual overlay network may send out an address resolution request to determine a default gateway address. A distributed gateway may subsequently intercept the address resolution request and respond back to the tenant end point with a designated distributed gateway address as the default gateway address. The distributed gateway may respond to the address resolution request when the distributed gateway has acquired the policy to route inter-network communication between the virtual overlay networks. Afterwards, a distributed gateway may receive traffic from the tenant end point and perform inter-network forwarding to route traffic between the two virtual overlay networks. In instances where the distributed gateway does not store the inter-network forwarding policy, the distributed gateway may forward the request and traffic to the gateway for inter-network based forwarding and policy checking.

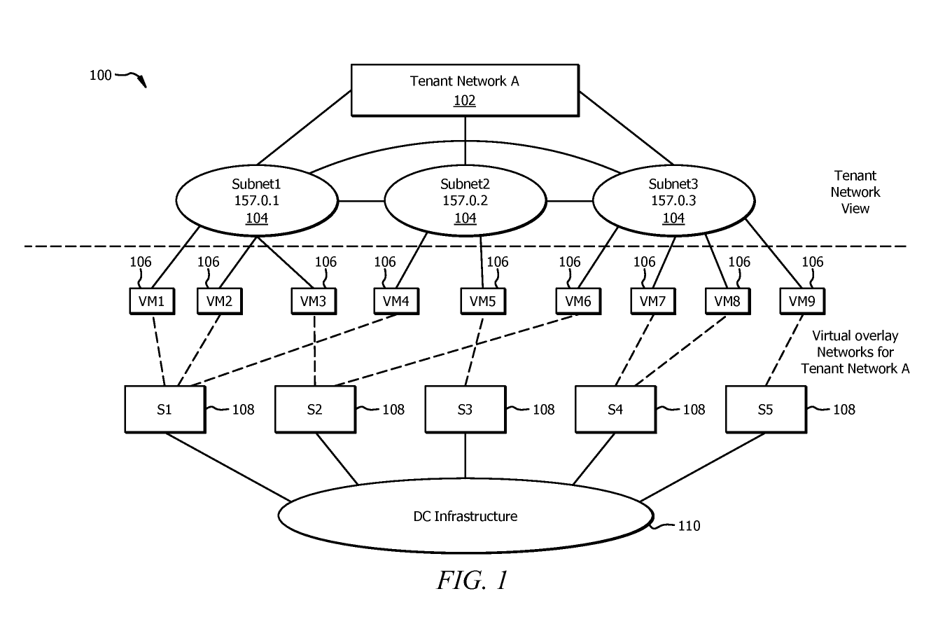

FIG. 1 is a schematic diagram of an example embodiment of a DC system 100 where embodiments of the present disclosure may operate. The DC system 100 may comprise one or more tenant networks 102 built on top of a DC infrastructure 110. The DC infrastructure 110 may comprise a plurality of access nodes (e.g. top of rack (ToR) switches), aggregation routers, core routers, gateway routers, and/or any other network device used to transport data within the DC system 100. The DC infrastructure 110 may also provide connectivity among servers 108 and/or to other external networks (e.g. Internet) located outside of DC system 100. One or more tenant networks 102 may be supported by the DC infrastructure 110. Each of the tenant networks 102 may be a virtual network that is decoupled from the DC infrastructure 110, but may rely on the DC infrastructure 110 to transport traffic. Each of the tenant networks 102 may be associated with its own set of tenant end points using the common DC infrastructure 110. In one example embodiment, each tenant network 102 may be configured with different default routing and/or gateway media access control (MAC) addresses for security concerns.

Each of the tenant networks 102 may comprise one or more virtual overlay networks. The virtual overlay network may provide Layer 2 (L2) and/or Layer 3 (L3) services that interconnect the tenant end points. FIG. 1 illustrates that DC system 100 may comprise a tenant network A 102 that is divided into three different virtual overlay networks, subnet network 1 104, subnet network 2 104, subnet network 3 104, collectively referred to as subnet networks 1-3 104. In other words, subnet networks 1-3 104 may be virtual overlay networks supported by the DC infrastructure 110 and used to form tenant network A 102. Subnet networks 1-3 104 may have independent address spaces, independent network configurations, and traffic isolation between each other. Tenant end points may include VMs 106 and/or any other type of end nodes (e.g. a host) used to originate and receive data to and from a subnet network 104. Each of the tenant end points may be assigned to one of the subnet networks 104. As shown in FIG. 1, VMs 1-3 106 are assigned to subnet network 1 104, VMs 4 and 5 106 are assigned to subnet network 2 104, and VMs 6-9 are assigned to subnet network 3 104.

A server controller system, not shown in FIG. 1, may be configured to create one or more tenant networks 102, virtual overlay networks (e.g. subnet networks 1-3 104), and/or tenant end points (e.g. VMs 1-9 106 on servers S1-S5 108). Within each of the tenant networks 102, the server controller system may create one or more subnet networks 104 and assign addresses for each of the subnet networks 104. As shown in FIG. 1, subnet network 1 104 has an address of 157.0.1, subnet network 2 104 has an address of 157.0.2, and subnet network 3 104 has an address of 157.0.3.

The server controller system may also be configured to verify connectivity in a tenant network 102, intra-network forwarding policies, and/or inter-network forwarding policies. Intra-network forwarding policies (e.g. intra-subnet forwarding policies) are policies used to forward traffic within a virtual overlay network. Inter-network forwarding policies (e.g. inter-subnet forwarding policies) are policies used to forward traffic between at least two virtual overlay networks. The inter-network forwarding policies may be a set of rules used to determine whether traffic from one virtual overlay network can be forwarded to another virtual overlay network. For example, the inter-network forwarding policies may be implemented using one or more access control lists that filter traffic received at a gateway or a distributed gateway. The gateway or distributed gateway examines each received data packet to determine whether to forward or drop the data packet based on one or more criteria specified within the access control lists. Criteria within the access control lists may include the source address of the data packet, the destination address of the traffic, upper-layer protocols (e.g. layer 4 protocols), port information, and/or other information used for network security and filtering. In one example embodiment, the gateway or distributed gateway may determine whether to forward a data packet to another virtual overlay network based on the source address of the data packet.

The server controller system may also be configured to create one or more tenant end points, such as VMs 106, and assign each of the tenant end points to one of the virtual overlay networks (e.g. subnet networks 1-3 104). A server controller system may place and/or move the tenant end points into any of the servers 108 associated with a tenant network 102. Using FIG. 1 as an example, the server controller system may initially place VMs 1, 2, and 4 106 within server S1 108, VMs 3 and 6 106 within server S2 108, VM 5 106 within server S3 108, VMs 7 and 8 106 within server S4 108, and VM 9 106 within server S5 108. The server controller system may subsequently move VM 1 106 from server S1 108 to server S2 108. The movement of VMs 106 and/or other tenant end points may occur while an application is running. Specifically, VMs 106 may be configured to install operating systems (OSs) (e.g. a client OS) and/or other applications. In one example embodiment, the server controller system may implement a Transmission Control Protocol (TCP) and/or IP to establish communication between the server controller system and one or more servers 108 within a tenant network 102. Controllers within the server controller system may communicate with each other via Extensible Markup Language (XML) and/or Hyper Text Markup Language (HTML). The server controller system or control plane can be implemented to facilitate the VM 106 location routing.

When tenant end points, such as VMs 106, are created and implemented on servers 108, servers 108 may be configured to provide communication for tenant end points located on the server 108. A virtual switching node, such as a virtual switch and/or router, can be created to route traffic amongst the tenant end point within a single server 108. The tenant end points within a server 108 may belong within the same virtual overlay network and/or a different virtual overlay network. Using FIG. 1 as an example, server S1 108 hosts VMs 1, 2, and 4 106. VMs 1 and 2 106 belong to subnet network 1 104 and VM 4 106 belongs to subnet network 2 104. A virtual switching node within server 1 108 may route traffic between VMs 1, 2, and 4 106, even though VM 4 106 is located within a different subnet network 104 than VMs 1 and 2 106.

Each of the servers 108 may also comprise an NVE to communicate with tenant end points within the same virtual overlay network, but located on different servers 108. An NVE may be configured to support L2 forwarding functions, L3 routing and forwarding functions, and support address resolution protocol (ARP) functions. The NVE may encapsulate traffic within a tenant network 102 and transport the traffic over a tunnel (e.g. L3 tunnel) between a pair of servers 108 or via a peer to multi-point (p2mp) tunnel for multicast transmission. The NVE may be configured to use a variety of encapsulation types that include, but are not limited to virtual extensible local area network (VXLAN) and Network Virtualization using Generic Routing Encapsulation (NVGRE). The NVE may be implemented as part of the virtual switching node (e.g. a virtual switch within a hypervisor) and/or as a physical access node (e.g. ToR switch). In other words, the NVE may exist within the server 108 or as separate physical device (e.g. ToR switch) depending on the application and DC environments. In addition, the NVE may be configured to ensure the communication policies for the tenant network 102 are enforced consistently across all the related servers 108.

As persons of ordinary skill in the art are aware, although FIG. 1 illustrates network virtualization overlay for a DC network, the disclosure is not limited to that application. For instance, although the disclosure places VMs 106 within servers 108, persons of ordinary skill in the art are also aware that other types of end nodes may be used as tenant end points within a tenant network. The use and discussion of FIG. 1 is only an example to facilitate ease of description and explanation.

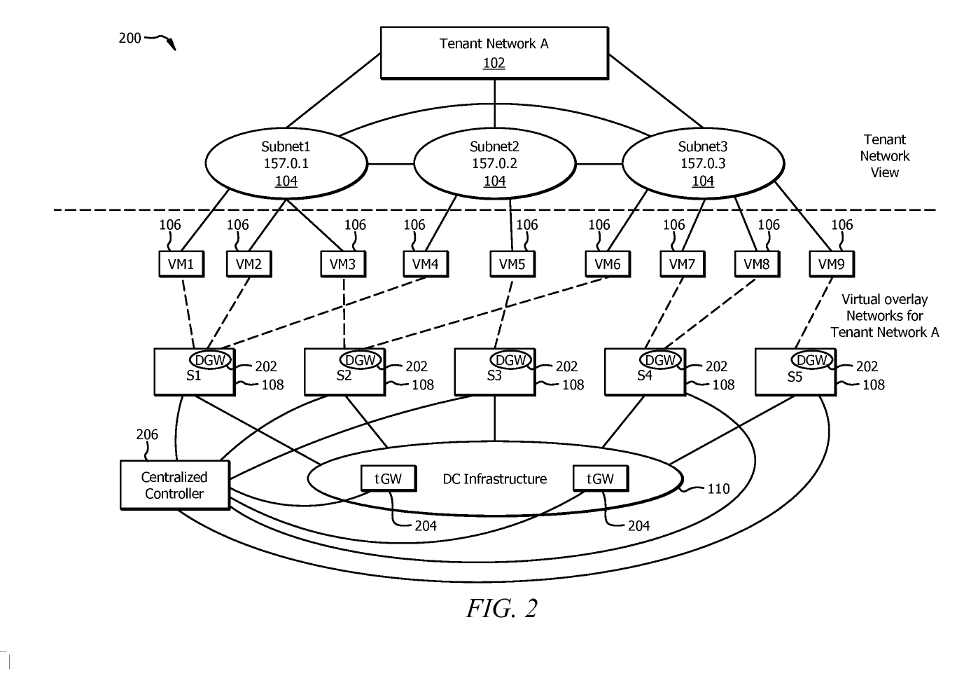

FIG. 2 is a schematic diagram of another example embodiment of a DC system 200 where embodiments of the present disclosure may operate. As shown in FIG. 2, DC system 200 may comprise a plurality of distributed gateways 202 located on the servers 108. The distributed gateways 202 may be located on a first hop network node from the tenant end points, such as an NVE. In one example embodiment, the NVE may be a virtual switching node that resides inside a server 108. In another example embodiment, the NVE may be located on a separate physical access node (e.g. ToR switch). A common distributed network address, such as a distributed MAC address, may be designated for at least some of the distributed gateways 202. In other words, the distributed gateways 202 may have the same distributed network address. By assigning a common distributed network address for the distributed gateways 202, a tenant end point may not need to update the distributed network address within memory (e.g. cache memory) when the tenant end point moves from one server 108 to another server 108. For example, if VM 1 106 was moved from server S1 108 to server S4 108, VM 1 106 may not need to update the distributed network address stored for VM 1 106. In FIG. 2, the distributed gateways 202 may track the MAC and IP address of the VMs 106 located within the servers 108.

The DC system 200 may also comprise a plurality of gateways 204 designated for tenant network A 102. The gateways 204 may be a virtual network node (e.g. implemented on a VM) or a physical network device (e.g. physical gateway node). FIG. 2 illustrates that the gateways 204 are physical network devices located within the DC infrastructure 110. The gateways 204 may be any node that relays traffic onto and off of a virtual overlay network. For example, gateways 204 may store an address mapping table used to map and forward traffic from one virtual overlay network to another virtual overlay network. Additionally, gateways 204 may also have a mapping table that forwards traffic between one virtual overlay network to another type of virtual network (e.g. L2 VLAN) and/or networks external to the DC system 200 (e.g. Internet). The gateway 204 may be configured to implement additional policies, authentication protocol, and/or other security protocols when communicating with an external network to DC system 200.

Tenant end points (e.g. VMs 106) may implement a variety of communication functions to communicate with different tenant end points. To discover other tenant end points within the same virtual overlay network, tenant end points may use an ARP and/or a network discovery (ND) protocol. For example, VM 1 106 on server S1 108 may initiate an ARP request to discover the MAC address for VM 3 106 on server S2 108 within subnet network 1 104. After discovery, a tenant end point may send packets to a destination tenant end point within the same virtual overlay network using the discovered destination address (e.g. destination MAC address) that references the destination tenant end point. In example embodiments where the distributed gateways 202 do not have the inter-network forwarding policies, the tenant end points may communicate with a gateway 204 to communicate with different tenant end points located in other virtual overlay networks. Tenant end points may use ARP and/or the ND protocol to discover a default gateway address (e.g. gateway MAC address). When a tenant end point sends a packet to a destination tenant end point located in a different virtual overlay network, the destination address may reference the default gateway address and the destination IP address may reference the IP address of the destination tenant end point.

At least some of the inter-network forwarding policies may be forwarded to distributed gateways 202 from gateways 204 and/or a centralized controller 206 (e.g. software-defined network (SDN) controller). In one example embodiment, each of the gateways 204 may store all of the inter-network forwarding policies for tenant network A 102 and forward at least some of the inter-network forwarding policies to distributed gateways 202. By distributing the inter-network forwarding policies to distributed gateways 202, the inter-network forwarding functions may be distributed to a virtualized switch within servers 108 and/or access nodes (e.g. ToR switches) instead of being performed at gateways 204. New inter-network forwarding policies may be distributed to the distributed gateways 202 when any changes occur in the virtual overlay networks attached to the distributed gateways 202.

Recall that a tenant end point attempts to resolve its default gateway address used to send traffic to a destination tenant end point located in another virtual overlay network by sending an address resolution request (e.g. ARP request). The address resolution request may be intercepted by a distributed gateway 202, and the distributed gateway 202 may respond with a designated distributed address shared amongst the distributed gateways 202 if the distributed gateway 202 has acquired the inter-network forwarding policies to forward traffic to the destination virtual overlay network. When the tenant end point receives the response to the address resolution request, the tenant end point stores the designated distributed address as the default gateway address. Otherwise, the distributed gateway 202 may forward the address resolution request and subsequent data traffic originating from the tenant end point to the gateway node if the distributed gateway 202 has not acquired the inter-network forwarding policy.

In one example embodiment, when the distributed gateway 202 is implemented within an NVE, the NVE may track which two virtual overlay networks the NVE can forward data packets. The NVE may perform L3 forwarding when allowed by the inter-network forwarding policy. In instances where the NVE is located on an access node and not on the same server 108 as the tenant end points, the NVE may use its own address (e.g. MAC address) as the default gateway address (e.g. gateway MAC address). For example, VM 1 106 may initiate an ARP message to obtain the default gateway MAC address, and the NVE located in an access node (e.g. ToR switch) may respond to the ARP message with its own physical MAC address. Additionally, when the VM 106 does not co-exist with the NVE and the VM 106 is moved from one server 108 to another sever 108, the moved VM 106 may need to obtain a different default gateway address. To provide the updated default gateway address, the NVE may issue a gratitude ARP message to a new VM 106 upon detecting the VM attachment. The VM 106 may update the default gateway address upon receiving the response. An NVE that also acts as a distributed gateway 202 may forward a data packet to a gateway 204 when the NVE does not have the inter-network forwarding policy.

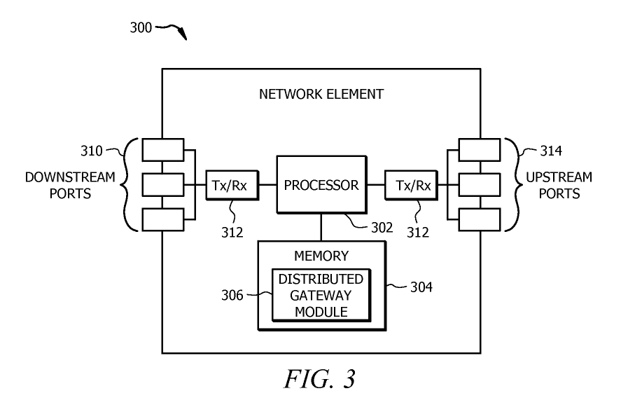

At least some of the features/methods described in the disclosure may be implemented in a network element. For instance, the features/methods of the disclosure may be implemented using hardware, firmware, and/or software installed to run on hardware. FIG. 3 is a schematic diagram of an embodiment of a network element 300 that may be used to implement a distributed gateway as described in FIG. 2. In one embodiment, the network element 300 may be any apparatus used to obtain, store, and use inter-network forwarding policies to route data packets between at least two or more virtual overlay networks. For example, network element 300 may be a distributed gateway implemented on a server, an access node (e.g. ToR switch), and/or an NVE.

The network element 300 may comprise one or more downstream ports 310 coupled to a transceiver (Tx/Rx) 312, which may be transmitters, receivers, or combinations thereof. The Tx/Rx 312 may transmit and/or receive frames from other network nodes via the downstream ports 310. Similarly, the network element 300 may comprise another Tx/Rx 312 coupled to a plurality of upstream ports 314, wherein the Tx/Rx 312 may transmit and/or receive frames from other nodes via the upstream ports 314. The downstream ports 310 and/or upstream ports 314 may include electrical and/or optical transmitting and/or receiving components.

A processor 302 may be coupled to the Tx/Rx 312 and may be configured to process the frames and/or determine which nodes to send (e.g. transmit) the frames. In one embodiment, the processor 302 may comprise one or more multi-core processors and/or memory modules 304, which may function as data stores, buffers, etc. The processor 302 may be implemented as a general processor or may be part of one or more application specific integrated circuits (ASICs) and/or digital signal processors (DSPs). Although illustrated as a single processor, the processor 302 is not so limited and may comprise multiple processors. The processor 302 may be configured to implement any of the schemes described herein, including method 500.

FIG. 3 illustrates that the memory module 304 may be coupled to the processor 302 and may be a non-transitory medium configured to store various types of data. Memory module 304 may comprise memory devices including secondary storage, read only memory (ROM), and random access memory (RAM). The secondary storage is typically comprised of one or more disk drives, solid-state drives (SSDs), and/or tape drives and is used for non-volatile storage of data and as an over-flow data storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and the RAM is typically faster than to the secondary storage.

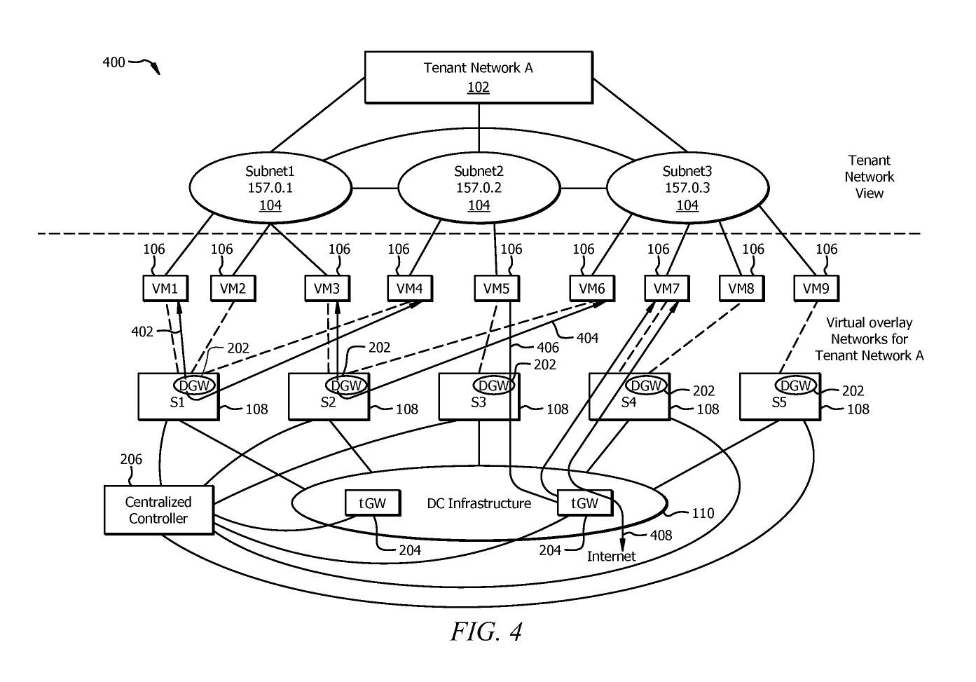

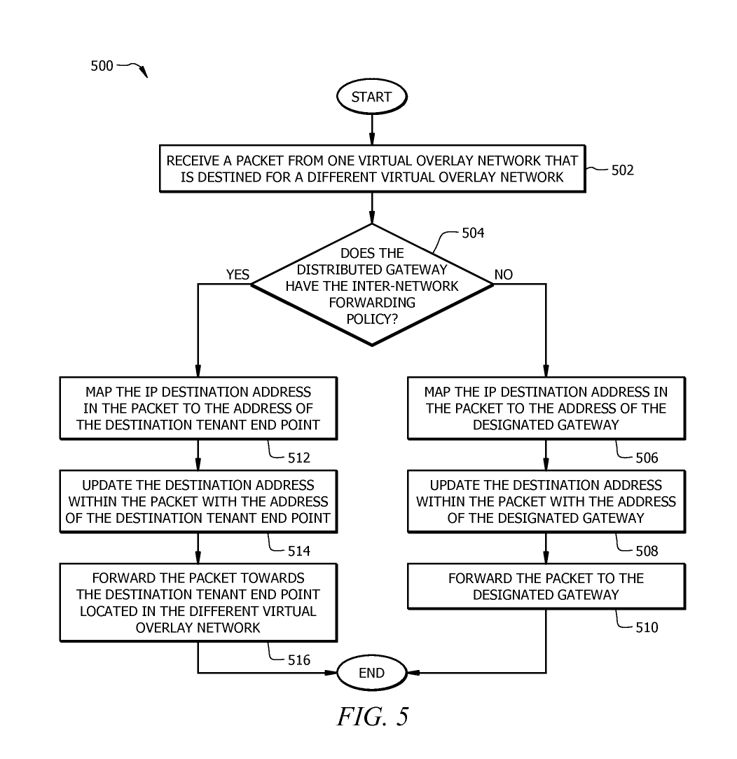

The memory module 304 may be used to house the instructions for carrying out the system and methods described herein, e.g. method 500 implemented at distributed gateway 202. In one example embodiment, the memory module 304 may comprise a distributed gateway module 306 that may be implemented on the processor 302. Alternately, the distributed gateway module 306 may be implemented directly on the processor 302. The distributed gateway module 306 may be configured to obtain, store, and use inter-network forwarding policies to route traffic between two virtual overlay networks. Functions performed by the distributed gateway module 306 have been discussed above in FIG. 2 and will also be disclosed in FIGS. 4 and 5.

It is understood that by programming and/or loading executable instructions onto the network element 300, at least one of the processor 302, the cache, and the long-term storage are changed, transforming the network element 300 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

FIG. 4 is a schematic diagram of another example embodiment of a DC system 400 where embodiments of the present disclosure may operate. Recall that distributed gateways 202 may obtain at least some of the inter-network forwarding policies from the gateway 204 and/or a centralized controller 206. Upon obtaining the inter-network forwarding policies, the distributed gateways 202 may perform forwarding between two virtual overlay networks in place of gateways 204. As such, data packets that are exchanged between two virtual overlay networks may be forwarded without traveling to one of the designated gateways 204. Similar to FIG. 2, FIG. 4 also illustrates that the distributed gateways 202 are located within servers 108. Each of the distributed gateways 202 may manage inter-network forwarding policies for each of the tenant end points located within a server 108. Although FIG. 4 illustrates that the distributed gateways 202 are located within a server 108, other example embodiments may have the distributed gateways 202 located within a separate network device, such as an access node (e.g. ToR switch). In the example embodiment where the distributed gateway 202 is located in an access node, the distributed gateway 202 may manage the inter-network forwarding policies for a plurality of tenant end points located on a plurality of servers 108.

In FIG. 4, routes 402 and 404 represent routes that exchange communication between VMs 106 located on different subnet networks 104 via distributed gateways 202. Specifically, route 402 may be used to exchange data packets between VM 1 106, which is located in subnet network 1 104, and VM 4 106, which is located in subnet network 2 104. Route 404 may be used to exchange data packets between VM 3 106, which is located in subnet network 1 104 and VM 6 106, which is located in subnet network 3 104. FIG. 4 illustrates that routes 402 and 404 have arrow heads on both sides to represent that data packets may be sent and/or received by either VMs 106. Routes 402 and 404 may optimize traffic by forwarding data packets to other virtual overlay networks without forwarding the traffic to the gateways 204. In another example embodiment where the distributed gateway 202 is located in an access node for servers S1-S5 108, the distributed gateway 202 may have the inter-network forwarding policies to forward data packets amongst VMs 1-9 106.

Using FIG. 4 as an example, when a data packet is sent from VM 1 106 to VM 4 106 or vice versa within route 402, the data packet is forwarded to distributed gateway 202 located within server 1 108. The data packet sent from VM 1 or 4 106 may be encapsulated with a destination address (e.g. destination MAC address) that references the distributed gateway 202 within server 1 108. In one example embodiment, the destination address may be the common distributed gateway address (e.g. distributed gateway MAC address) assigned to distributed gateways 202. After the distributed gateway 202 within server 1 108 receives the data packet, the distributed gateway 202 may check and determine that it has the inter-network forwarding policy to route data packets between subnet network 1 104 and subnet network 2 104. Alternatively, if the distributed gateway 202 does not have the inter-network forwarding policy, the distributed gateway 202 may query the inter-network forwarding policy from a centralized controller 206 (e.g. SDN controller). Once the distributed gateway 202 receives the inter-network forwarding policy, the distributed gateway 202 may check the received data packets against the inter-network forwarding policy received from the centralized controller 206 (e.g. SDN controller).

The distributed gateway 202 within server 1 108 may then update the destination address and/or virtual network identifier (VN ID) within the received data packet. The destination address within the received data packet may be updated from the address that references the distributed gateway 202 with the address of the destination VM 106. For example, if VM 1 106 sent the data packet, the updated destination address may reference VM 4 106. The VN ID within the received data packet may be updated with a VN ID that references the virtual overlay network of the destination VM 106. After updating the destination address, the distributed gateway 202 may forward the data packet toward the destination VM 106. In some of the example embodiments, an additional header (e.g. L3 header) may be encapsulated to forward the data packet to a network node (e.g. another NVE) that subsequently forwards the data packet to the destination VM 106. The L3 header may comprise one or more destination address fields (e.g. IP address field and MAC address field) that references the address of a network node located along route 402. For example, the distributed gateway 202 may forward the data packet to a destination NVE coupled to VM 4 106 by encapsulating the destination address fields within the L3 header to reference the address of the destination NVE.

Route 406 represents a route used to exchange data packets when distributed gateways 202 do not have the inter-network forwarding policies. As shown in FIG. 4, route 406 has only one arrow head, which represents that route 406 may be used to forward data packets from VM 5 106, which is located in subnet network 2 104, to VM 7 106, which is located in subnet network 3 104, but not vice-versa. In route 406, the VM 5 106 may initially send a packet destined for VM 7 106. The data packet may initially be encapsulated with a destination address that references the distributed gateway 202 within server S3 108. After the distributed gateway 202 within server S3 108 receives the data packet, the distributed gateway 202 may check and determine that it does not have the inter-network forwarding policy for the data packet. The distributed gateway 202 may then update the destination address within the data packet with the address that references the gateway 204 within the data packet. Afterwards, the distributed gateway 202 may forward the data packet to the gateway 204, which will map and route the data packet via route 406 to reach VM 7 106.

Route 408 may represent a route used to exchange data packets from a virtual overlay network to an external network (e.g. Internet). FIG. 4 illustrates that route 408 has arrow heads on both sides, which signifies that route 408 may send and/or receive data packets by VM 7 106 and/or from the Internet. In other words, route 408 may be used to exchange data packets between VM 7 106 and an external network, such as the Internet. For example, in route 408, VM 7 106 may initially send a packet destined for the Internet. The data packet may initially be encapsulated with a destination address that references the distributed gateway 202 within server S4 108. After the distributed gateway 202 within server S4 108 receives the data packet, the distributed gateway 202 may determine that the data packet is destined for an external network. The distributed gateway 202 may then update the destination address within the data packet with an address that references gateway 204 within the data packet. Afterwards, the distributed gateway 202 forwards the data packet to gateway 204, which will map and route the data packet to the Internet.

FIG. 5 illustrates a flowchart of an example embodiment of a method 500 for routing data packets between two virtual overlay networks. Method 500 may be implemented within a distributed gateway, such as the distributed gateway 202 described in FIG. 2. The distributed gateway may be located within a server or on a separate physical access node. Prior to implementing method 500, the distributed gateway may obtain a designated distributed gateway network address that may be assigned by a network operator and/or obtained from a central controller system. The distributed gateway may advertise the designated distributed gateway network address to one or more tenant end points. For example, the distributed gateway may also advertise the designated distributed gateway network address by responding to address resolution requests (e.g. ARP requests) that are used to obtain the default gateway address for the tenant end points. Recall that the distributed gateway may obtain inter-network forwarding policies for one or more virtual overlay networks from a gateway and/or a central controller.

Method 500 may start at block 502 and receive a packet from one virtual overlay network that is destined for a different virtual overlay network. For example, the packet may comprise a source MAC address and source IP address that references a tenant end point in a first virtual overlay network and a VN ID that identifies the first virtual overlay network. The packet may also comprise a destination IP address that references a second tenant end point in a second virtual overlay network. Method 500 may then move to block 504 to determine whether the distributed gateway has the inter-network forwarding policy for the packet. Specifically, method 500 may determine whether the distributed gateway has the inter-network forwarding policy by mapping the destination IP address to a destination virtual overlay network and determining whether method 500 has an inter-network forwarding policy for the destination virtual overlay network. If method 500 determines that the distributed gateway does not have the inter-network forwarding policy for the packet, then method 500 may move to block 506. Otherwise, method 500 may move to block 512 when the distributed gateway has the inter-network forwarding policy.

At block 506, method 500 may map the IP destination address in the packet to the address of the designated gateway (e.g. gateway MAC address). A distributed gateway may store a mapping table used to map a plurality of IP addresses that correspond to different tenant end points to the designated gateway address. Afterwards, method 500 moves to block 508 and updates the destination address within the packet with the address of the designated gateway. Method 500 may proceed to block 510 and forward the packet to the designated gateway. In one example embodiment, an additional header (e.g. L3 header) may not be encapsulated to the packet when the packet is transmitted to and from the designated gateway (e.g. default gateway participating in the virtual overlay network).

At block 512, method 500 may map the IP destination address in the packet to the address of the destination tenant end point (e.g. MAC address of the tenant end point). A distributed gateway may also store a mapping table used to map a plurality of IP addresses that correspond to different tenant end points to a plurality of destination addresses for the different end nodes. Moreover, at block 512, method 500 may perform virtual overlay network interworking by translating the VN ID. The packet may initially be encapsulated with the VN ID that identifies the first virtual overlay network (e.g. the source virtual overlay network). At block 512, method 500 may translate the VN ID within the packet to the destination VN ID that references the virtual overlay network for the destination tenant end point. Method 500 may translate the VN ID using a mapping table that maps the IP destination address received in the packet to the destination VN ID that references the virtual overlay network for the destination tenant end point.

Afterwards, method 500 moves to block 514 and updates the destination address within the packet with the address of the destination tenant end point. In an example embodiment, an additional header (e.g. L3 header) may be encapsulated that includes the address(es) of the last hop node (e.g. IP and MAC address of the destination NVE) that forwards the packet to the destination tenant end point. Method 500 may then proceed to block 516 and forward the packet towards the destination tenant end point located in the different virtual overlay network.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

We claim:

1. A method for distributing inter-network forwarding policies to a network virtualization edge (NVE) that comprises a distributed gateway within a network, the method comprising:
receiving a data packet from a first virtual overlay network;
determining that the data packet is destined for a destination end point located within a second virtual overlay network;
determining whether the data packet corresponds to an inter-network forwarding policy stored within the distributed gateway; and
forwarding the data packet toward a gateway based on the determination that the data packet does not correspond to the inter-network forwarding policy,
wherein the inter-network forwarding policy is a set of rules used to forward traffic between the first virtual overlay network and the second virtual overlay network.

2. The method of claim 1, further comprising:
receiving an address resolution request within the first virtual overlay network; and
responding to the address resolution request with the address of the distributed gateway,
wherein the address resolution request is a request for a gateway address within the network.

3. The method of claim 2, wherein the address of the distributed gateway is a common address assigned to a plurality of distributed gateways within the network.

4. The method of claim 1, further comprising obtaining the inter-network forwarding policy from a software defined network (SDN) controller or querying the policy from the SDN controller.

5. The method of claim 1, further comprising obtaining the inter-network forwarding policy from the gateway within the network.

6. The method of claim 1, further comprising determining the destination end point is in the first virtual overlay network and forwarding the packet to the destination end point without passing the distributed gateway.

7. The method of claim 1, further comprising:
passing the data packet to the distributed gateway where the inter-network forwarding policy applies to the data packet; and
forwarding the data packet to the designated gateway based upon the determination that the distributed gateway does not have the inter-network forwarding policy to the data packet.

8. The method of claim 1, further comprising:
mapping an Internet Protocol (IP) destination address within the data packet to a destination address of a destination NVE that forwards the data packet to the destination end point;
encapsulating a destination address field within the data packet that references the destination address of a destination NVE based on the determination that the data packet corresponds to the inter-network forwarding policy; and
forwarding the data packet toward the destination NVE based on the determination that the data packet corresponds to the inter-network forwarding policy,
wherein the destination address field is encapsulated as a layer 3 (L3) header prior to forwarding the data packet toward the destination NVE.

9. The method of claim 1, further comprising updating a destination address field within the data packet with a gateway address that references a gateway located in the network based on the determination that the data packet does not correspond to the inter-network forwarding policy.

10. The method of claim 1, further comprising updating a virtual network identifier (VN ID) field within the data packet with a VN ID that references the second virtual overlay network based on the determination that the data packet corresponds to the inter-network forwarding policy.

11. The method of claim 1, further comprising forwarding the data packet toward the destination end point located within the second virtual overlay network based on the determination that the data packet corresponds to the inter-network forwarding policy.

12. A computer program product comprising computer executable instructions stored on a non-transitory computer readable medium that when executed by a processor causes a node to perform the following:
store a plurality of inter-network forwarding policies for a tenant network;
receive a data packet within a source virtual overlay network located in the tenant network;
determine a destination virtual overlay network located in the tenant network for the data packet;
determine whether one of the inter-network forwarding policies is associated with the destination virtual overlay network; and
forward the data packet toward a designated gateway based on the determination that the destination virtual overlay network is not associated with the one of the inter-network forwarding policies,
wherein the inter-network forwarding policies are a plurality of rules used to exchange traffic between a plurality of virtual overlay networks located within the tenant network.

13. The computer program product of claim 12, wherein the instructions, when executed by the processor, further cause the node to forward the data packet toward a destination end point located within the destination virtual overlay network based on the determination that the destination virtual overlay network is associated with the one of the inter-network forwarding policies.

14. The computer program product of claim 12, wherein the instructions, when executed by the processor, further cause the node to:
receive an address resolution request that indicates a request for a default gateway address; and
respond with an address that references the node,
wherein the address that references the node is an assigned address that is shared amongst a plurality of distributed gateways located within the tenant network.

15. The computer program product of claim 12, wherein the data packet comprises a destination address field that references an address of the node, and wherein the instructions, when executed by the processor, further cause the node to update the destination field such that the destination address field references at least one of the following: an address of the designated gateway based on the determination that the destination virtual overlay network is not associated with the one of the inter-network forwarding policies and an address of the destination end point based on the determination that the destination virtual overlay network is associated with the one of the inter-network forwarding policies.

16. The computer program product of claim 12, wherein the data packet comprises an Internet Protocol (IP) destination address field that references an IP address of the destination end point, and wherein the instructions, when executed by the processor, further cause the node to:
map the IP destination address field to obtain an address of the destination end point and a destination virtual network identifier (VN ID);
update a destination address field within the data packet with the address of the destination end point; and
update a VN ID field within the data packet within the destination VN ID.

17. An apparatus for providing inter-network forwarding, comprising:
a receiver configured to receive, within a first virtual network, a data packet comprising an Internet Protocol (IP) destination address and a destination address, wherein the IP destination address references an IP address of a destination end point, wherein the destination address references an address of the apparatus;
a processor coupled to the receiver, wherein the processor is configured to:
map the IP destination address to a destination address of the destination point and a destination virtual network; and
determine whether an inter-network forwarding policy is stored within the apparatus to forward data packets to the destination virtual network; and
a transmitter coupled to the processor, wherein the transmitter is configured to:
transmit the data packet toward a designated gateway based on the determination that the apparatus does not store the inter-network forwarding policy used to forward the data packet to the destination virtual network,
wherein the inter-network forwarding policy determines whether the data packet is exchanged between the first virtual network and the second virtual network.

18. The apparatus of claim 17, wherein the transmitter is further configured to transmit the data packet toward the destination end point based on the determination that the apparatus stores the inter-network forwarding policy used to forward the data packet to the destination virtual network.

19. The apparatus of claim 17, wherein the processor is further configured to map the IP destination address to a destination address of a network virtualization edge (NVE) that forwards the data packet to the destination end point and encapsulate the destination address of the NVE within a layer 3 (L3) outer header, and wherein the transmitter is configured to transmit the data packet to the NVE after encapsulating the L3 header when the apparatus stores the inter-network forwarding policy.

20. The apparatus of claim 17, wherein the apparatus is located within at least one of the following: within a sever and within an access node.
